(19) United States
(12) Patent Application Publication
(10) Pub. No.: US 2012/0028147 A1
(43) Pub. Date: Feb. 2, 2012

(54) FUEL CELL VEHICLE AND METHOD FOR CONTROLLING OPERATION OF THE SAME

(75) Inventors: Chang Hwan Ye, Osan (KR); Jeong Kyu Park, Yongin (KR); Hyun Jun Kim, Yongin (KR)

(73) Assignee: HYUNDAI MOTOR COMPANY, Seoul (KR)

(21) Appl. No.: 12/959,472

(22) Filed: Dec. 3, 2010

(30) Foreign Application Priority Data
Aug. 2, 2010 (KR) 10-2010-0074678

(51) Int. Cl. H01M 8/04

(52) U.S. Cl. 429/429

(57) ABSTRACT

A fuel cell vehicle includes a stack that generates electrical energy by a fuel gas, a blower that blows air into the stack, an air cut-off valve that is mounted on an air supply line, a bypass line diverged between the air cut-off valve and the blower and having an end portion that is opened, a bypass valve that is mounted on the bypass line, and a control portion that closes the air cut-off valve and opens the bypass valve upon detecting an off signal for idle engine stop or a signal for turning off the engine. Therefore, if the fuel cell vehicle is in an idle stop condition, the blower supplying the stack with air stops operating, and simultaneously the bypass line is opened and the air cut-off valve is closed such that the air supplied to the stack can be securely cut off.

### CROSS-REFERENCE TO RELATED APPLICATION

This application claims priority to and the benefit of Korean Patent Application No. 10-2010-0074678 filed in the Korean Intellectual Property Office on Aug. 2, 2010, the entire contents of which are incorporated herein by reference.

### BACKGROUND OF THE INVENTION

(a) Field of the Invention

The present invention relates to a fuel cell vehicle that uses a fuel gas and air to generate electricity and driving torque, and a method for controlling operation of the fuel cell vehicle.

(b) Description of the Related Art

Generally, a fuel cell stack used for a vehicle is a solid high-molecule electrolyte type fuel cell (proton exchange membrane fuel cell: PEMFC) having a high output density. In a conventional solid high-molecule electrolyte type fuel cell, hydrogen is supplied to an anode (fuel pole) and oxygen from air is supplied to a cathode (air pole). Only hydrogen ions (H+) of the hydrogen supplied to the anode selectively penetrate an electrolyte film as a positive ion exchange film by a catalyst of an electrode layer formed at both sides of the electrolyte film to be transferred to the cathode, and simultaneously electrons are transferred to the cathode through a conductive gas diffusion layer and a separating plate. The hydrogen ions supplied through the electrolyte film and the electrons transferred through the separating plate react with oxygen of the air supplied to the cathode by an air supply device to form water on the cathode. A current resulting from a flow of the hydrogen ions is formed as a flow of electrons through a conductive wire, and heat resulting from the water formation reaction is generated. The electrolyte film must be sufficiently wetted so as to normally operate the fuel cell, but as the atmospheric air is not sufficiently damp to wet the film, the air needs to be humidified by a humidifier before being supplied to the fuel cell.

Additionally, if a starting off signal is detected during operation by the fuel cell, it is necessary to cut off the air supplied to the stack so as to reduce the fuel gas from being consumed by the stack and to prevent the stack from being dried.

However, in a case that an air cut-off valve is closed so as to cut off the air in an idle engine stop or a starting off condition, since there is no bypass line, the pressure of the supply line can be raised undesirably, which may negatively affect performance of a vehicle incorporating the solid high-molecule electrolyte type fuel cell stack.

The above information disclosed in this Background section is only for enhancement of understanding of the background of the invention and therefore it may contain information that does not form the prior art that is already known in this country to a person of ordinary skill in the art.

### SUMMARY OF THE INVENTION

In one aspect, the present invention provides a fuel cell vehicle capable of cutting off air supplied to a stack so as to prevent the stack from being dried out and to reduce fuel consumption when an engine is turned off.

A fuel cell vehicle according to an exemplary embodiment of the present invention preferably includes at least a stack that is configured to generate electrical energy by a fuel gas, a blower that is configured to blow air into the stack, an air cut-off valve that is mounted on an air supply line, a bypass line that diverges between the air cut-off valve and the blower, where an end portion of the bypass line is opened, a bypass valve that is mounted on the bypass line, and a control portion that closes the air cut-off valve and opens the bypass valve upon detecting an off signal for idle engine stop or a signal for turning off the engine.

The fuel cell vehicle optionally can include a humidifier that is mounted between the air cut-off valve and the stack to humidify the air supplied to the stack.

In a fuel cell vehicle according to the present invention, if the fuel cell vehicle is in an idle stop condition, the blower supplying the stack with the air ceases operation, and simultaneously the bypass line is opened and the air cut-off valve is closed such that the air supplied to the stack is securely cut off.

A method for operating a fuel cell vehicle, can include steps of: providing at least a stack for generating electrical energy by a fuel gas, a blower configured to blow air into the stack, an air cut-off valve mounted on an air supply line, a bypass line that diverges between the air cut-off valve and the blower, and a bypass valve mounted on the bypass line; determining whether the fuel cell vehicle is turned off or is in an idle engine stop condition; and if the fuel cell vehicle reaches the idle engine stop condition or is turned off, then stopping operation of the blower, opening the bypass valve, and closing the air cut-off value, so as to interrupt air supply to the stack.

### BRIEF DESCRIPTION OF THE DRAWINGS

FIG. 1 is a schematic view of a fuel cell vehicle according to an exemplary embodiment of the present invention.

FIG. 2 is a flowchart depicting a method for controlling a fuel cell vehicle according to an exemplary embodiment of the present invention.

### DESCRIPTION OF SYMBOLS

100: stack
110: humidifier
120: blower
130: air cut-off valve
140: bypass valve
150: bypass line
160: control portion

### DETAILED DESCRIPTION OF PREFERRED EMBODIMENTS

An exemplary embodiment of the present invention will hereinafter be described in detail with reference to the accompanying drawings.

As those skilled in the art would realize, the described embodiments may be modified in various different ways, all without departing from the spirit or scope of the present invention. Description of components that are not necessary for explaining the present invention will be omitted, and the same constituent elements are denoted by the same reference numerals in this specification.

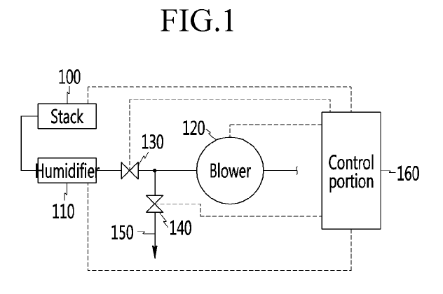

FIG. 1 is a schematic view of a fuel cell vehicle according to an exemplary embodiment of the present invention.

Referring to FIG. 1, a fuel cell vehicle includes a stack 100, a humidifier 110, a blower 120, an air cut-off valve 130, a bypass line 150, a bypass valve 140, and a control portion 160.

The stack 100 uses hydrogen and oxygen to generate electricity, where the generated electricity operates a motor to move a vehicle, and the blower 120 supplies the stack 100 with air including oxygen.

The humidifier 110 is disposed on an air supply line formed between the stack 100 and the blower 120 to humidify the air supplied to the stack 100.

Further, the air cut-off valve 130 is disposed between the humidifier 110 and the blower 120, and the bypass line 150 diverges between the air cut-off valve 130 and the blower 120. One end of the bypass line 150 preferably is opened to the outside, and the bypass valve 140 is disposed on one side of the bypass line 150.

The control portion 160 controls the stack 100, the humidifier 110, the air cut-off valve 130, the bypass valve 140, and the blower 120, and detects operating signals from these respective components. In addition, the control portion 160 detects driving conditions of its own vehicle from several sensors, and determines whether the fuel cell vehicle is in a starting off condition (for example, in which the vehicle engine is turned off) or an idle stop condition (for example, in which the engine is turned off during an idle condition of the engine). The starting off condition can be detected from a position of an ignition key, and the idle stop condition can be detected from the size of a voltage (S/CAP), although other detection arrangements can be used.

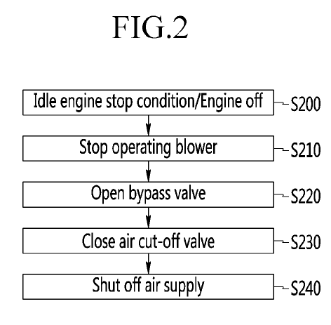

FIG. 2 is a flowchart depicting a method for controlling a fuel cell vehicle according to an exemplary embodiment of the present invention.

Referring to FIG. 2, in step S200, it is determined whether a vehicle is turned off or is in an idle engine stop condition.

In an exemplary embodiment of the present invention, if an S/CAP voltage is reduced so as to reach an idle stop area, it can be determined that the vehicle is in an idle engine stop condition. Further, an engine stop condition can be detected from the position of an ignition key.

As described above, if a fuel cell vehicle reaches the idle engine stop condition or is turned off, the blower 120 stops operating in step S210, the bypass valve 140 is opened in step S220, and the air cut-off valve 130 is closed in step S230. Accordingly, the air supply to the stack 100 is quickly interrupted in step S240.

Even if the control portion stops operation of the blower, the blower supplies air for some seconds by rotational inertia of the blower. However, according to the present invention, the air cut-off valve is closed and the bypass valve is opened such that the air can be exhausted easily. Even if the air cut-off valve is not functioning properly, the bypass valve can be opened to cut off air supply to the stack.

Steps S210, S220, S230 can be simultaneously or sequentially performed, or the order can be varied according to an exemplary embodiment of the present invention. For example, the order can be S210->S230->S220, S220->S230->S210, or S220->S210->S230.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A fuel cell vehicle comprising:
a stack configured to generate electrical energy by a fuel gas;
a blower configured to blow air into the stack;
an air cut-off valve mounted on an air supply line of the fuel cell vehicle;
a bypass line that diverges between the air cut-off valve and the blower, wherein an end portion of the bypass line is opened;
a bypass valve mounted on the bypass line; and
a control portion for closing the air cut-off valve and opening the bypass valve upon detection of an off signal for idle engine stop or a signal for turning off the engine.

2. The fuel cell vehicle of claim 1, further comprising a humidifier mounted between the air cut-off valve and the stack so as to humidify the air supplied to the stack.

3. The fuel cell vehicle of claim 1, wherein the off signal for idle engine stop or the signal for turning off the engine are detected by monitoring an S/CAP voltage or a position of an ignition key.

4. A method for operating a fuel cell vehicle, comprising steps of:
providing at least a stack for generating electrical energy by a fuel gas, a blower configured to blow air into the stack, an air cut-off valve mounted on an air supply line, a bypass line that diverges between the air cut-off valve and the blower, and a bypass valve mounted on the bypass line;
determining whether the fuel cell vehicle is turned off or is in an idle engine stop condition;
and if the fuel cell vehicle reaches the idle engine stop condition or is turned off, then stopping operation of the blower, opening the bypass valve, and closing the air cut-off value, so as to interrupt air supply to the stack.
